(19) United States
(12) Patent Application Publication
(10) Pub. No.: US 2026/0221152 A1
(43) Pub. Date: Jul. 30, 2026

(54) AIR BEARING DESIGN FOR HIGH OXYGEN PARTIAL PRESSURE FOR HEAT-ASSISTED MAGNETIC RECORDING

(71) Applicant: Western Digital Technologies, Inc., San Jose, CA (US)

(72) Inventors: Biao SUN, Fremont, CA (US); Yong HU, San Ramon, CA (US)

(73) Assignee: Western Digital Technologies, Inc., San Jose, CA (US)

(21) Appl. No.: 19/040,994

(22) Filed: Jan. 30, 2025

(51) Int. Cl. G11B 5/48; G11B 5/60

(52) U.S. Cl. CPC G11B 5/4826; G11B 5/607; G11B 5/6082; G11B 2220/2516

(57) ABSTRACT

Disclosed herein are sliders with at least one notch in the trailing pad, methods of making them, and data storage devices comprising them. In some embodiments, a slider comprises a leading-edge surface, a trailing-edge surface, and an air-bearing surface (ABS) that includes a trailing pad situated closer to the trailing-edge surface than to the leading-edge surface, wherein the trailing pad comprises a main portion, a mini-pad situated between the main portion and the trailing-edge surface, and a neck portion connecting the mini-pad to the main portion, wherein a minimum width of the neck portion in a cross-track direction is less than a minimum width of the mini-pad in the cross-track direction.

### BACKGROUND

Data storage devices, such as hard disk drives, are used to store large amounts of information. In magnetic storage systems, a magnetic head typically includes read and write transducers that allow magnetically encoded information on a magnetic recording medium, such as a disk, to be stored and retrieved.

The need to increase storage densities has led to the development of data storage technologies such as microwave-assisted magnetic recording (MAMR) and heat-assisted magnetic recording (HAMR). In MAMR, elements added to the recording head generate an additional field that supplements the magnetic field ordinarily produced by the write transducer, thereby providing a stronger effective write field. In HAMR, elements added to the recording head heat a localized area on the surface of the recording media to reduce its coercivity, thereby enabling the magnetic field generated by the write transducer, which otherwise would be of insufficient strength, to set the magnetization of the localized area. Both of these techniques can result in the recording head operating at higher temperatures than recording heads in conventional hard drives, which can shorten the lifetime of the data storage device.

Accordingly, there is a need for techniques that can provide improvements.

### SUMMARY

This summary represents non-limiting embodiments of the disclosure.

In some aspects, the techniques described herein relate to a slider for a data storage device, the slider including: a leading-edge surface; a trailing-edge surface, wherein the trailing-edge surface is substantially parallel to the leading-edge surface; and a trailing pad situated closer to the trailing-edge surface than to the leading-edge surface, wherein the trailing pad includes: a main portion, a mini-pad situated between the main portion and the trailing-edge surface, and a neck portion connecting the mini-pad to the main portion, wherein a minimum width of the neck portion in a cross-track direction is less than a minimum width of the mini-pad in the cross-track direction.

In some aspects, in an air-bearing surface (ABS) view of the slider, a shape of the mini-pad is substantially rectangular.

In some aspects, in an ABS view of the slider, at least one surface of a rear edge of the main portion of the trailing pad is not parallel to the trailing-edge surface.

In some aspects, in an ABS view of the slider, the neck portion is substantially hourglass-shaped.

In some aspects, in an ABS view of the slider, a first width of the neck portion in the cross-track direction at a first distance from the trailing-edge surface differs from a second width of the neck portion in the cross-track direction at a second distance from the trailing-edge surface.

In some aspects, in an ABS view of the slider, the neck portion includes at least one notch. In some aspects, the at least one notch includes a first notch on an outer-diameter side and a second notch on an inner-diameter side. In some aspects, a shape of the first notch differs from a shape of the second notch. In some aspects, a volume of the first notch is larger than a volume of the second notch. In some aspects, a shape of at least one of the first notch or the second notch is irregular.

In some aspects, the techniques described herein relate to a method of manufacturing a slider having at least one notch, the method including: applying a mask to the slider, wherein the mask exposes a first region corresponding to the at least one notch; and while the mask is in place, performing an etching step to create the at least one notch.

In some aspects, the trailing pad further includes an efficiency-flattening hole (EFH) and a recording head situated between the EFH and the trailing-edge surface.

In some aspects, the techniques described herein relate to a data storage device, including: a recording medium; and a slider including: a leading-edge surface, a trailing-edge surface substantially parallel to the leading-edge surface, and an ABS, including: a trailing pad situated closer to the trailing-edge surface than to the leading-edge surface, wherein the trailing pad includes: a main portion, a mini-pad extending from the main portion toward the trailing-edge surface, and at least one notch between the mini-pad and the main portion of the trailing pad.

In some aspects, the at least one notch includes: a first notch on an outer-diameter side of the mini-pad; and a second notch on an inner-diameter side of the mini-pad. In some aspects, in an ABS view of the slider, a shape of the first notch differs from a shape of the second notch. In some aspects, the shape of the first notch is irregular and/or the shape of the second notch is irregular. In some aspects, the shape of the first notch or the shape of the second notch is a piecewise-linear shape. In some aspects, a volume of the first notch is larger than a volume of the second notch.

In some aspects, the ABS further includes an EFH and a recording head situated on the mini-pad, wherein the mini-pad is situated between the EFH and the trailing-edge surface.

In some aspects, the techniques described herein relate to a data storage device, including: a recording medium; and a slider, including: means for writing to the recording medium; and a trailing pad, including: a main portion, a mini-pad extending from the main portion toward a trailing-edge of the slider, and a neck portion connecting the mini-pad to the main portion, wherein a minimum width of the neck portion in a cross-track direction is less than a minimum width of the mini-pad in the cross-track direction.

### BRIEF DESCRIPTION OF THE DRAWINGS

Objects, features, and advantages of the disclosure will be readily apparent from the following description of certain embodiments taken in conjunction with the accompanying drawings in which:

FIG. 1 is a plan view of an example of a data storage device, illustrated as a hard disk drive, that may include one or more of the embodiments disclosed herein.

FIG. 2 is a diagram showing skew angles of a slider at different positions with respect to the recording medium in accordance with some embodiments.

FIG. 3 illustrates an exemplary touchdown power profile for an example slider in accordance with some embodiments.

FIGS. 4A, 4B, and 4C illustrate a prior art slider.

FIGS. 5A, 5B, 5C, 5D, and 5E illustrate an example of a slider with a new ABS design in accordance with some embodiments.

FIG. 6 is a flow diagram illustrating a portion of a method of fabricating a slider with a mini-pad and notches in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

### DETAILED DESCRIPTION

Recording technologies such as HAMR and MAMR can result in the recording head operating at higher temperatures than recording heads in conventional hard drives, which can shorten the lifetime of the data storage device. For example, a potential issue with HAMR devices is that excessive heating of the near-field transducer (NFT) used in the heating process can cause performance degradation and eventually failure of the data storage device. One contributing factor to excessive heating may be adsorption of carbonaceous material on the slider overcoat near the NFT tip. Relative to data storage devices that use older recording technologies such as perpendicular magnetic recording, HAMR devices tend to have a thicker carbon overcoat on the media. Hydrocarbon molecules from the recording media overcoat and lubricant can become mobile at elevated temperatures and adsorb on the air-bearing surface (ABS) of the slider. Over time, these molecules can form a “smear” on the ABS that absorbs power from the laser source and causes the NFT, which normally operates at very high temperatures, to become even hotter than usual. The heat transfer can result in diffusion of the NFT metal until the NFT tip rounds and its performance degrades, eventually possibly leading to failure of the data storage device.

In addition to potentially affecting the NFT, smear can affect the fly height of the slider in a manner that varies over time. The carbonaceous material can build up as the data storage device operates and then become detached (e.g., when thick enough that it touches the recording media and drops off). Accordingly, the changing characteristics of smear (e.g., its presence, thickness, etc.) can cause variations in the slider fly height. These variations can adversely affect the performance of the data storage device, such as its writing performance.

Smear can contain materials such as carbon, silicon, and/or nitrogen. Consequently, if the smear is hot enough while in the presence of enough oxygen, it can oxidize and produce glassy products (e.g., materials that have amorphous, non-crystalline structures similar to that of glass, such as, e.g., SiO₂) and/or carbon-based gases (CO, CO₂, etc.), or combinations thereof. The produced gases dissipate, and the HAMR head's laser light can typically penetrate the resulting glassy products (if present) without heating them, which provides the desired heating of the recording media while preventing excessive heating of the NFT, which can substantially improve the lifetime of the NFT. This oxidation process consumes oxygen molecules inside of the data storage device.

Many older data storage devices operate in a standard air (e.g., nitrogen, oxygen, and water vapor mixture) atmosphere. Spinning recording media in hard disk drives at high revolutions per minute against the friction of an air atmosphere is relatively inefficient and requires a certain amount of power. To address this inefficiency, a data storage device can be filled at least partially with a lower-density gas, such as helium or hydrogen, and sealed to control and maintain the internal environment of the data storage device. Sealing mitigates or prevents leakage of internal gases from within the data storage device. The use of helium, which has a density that is approximately one-seventh that of air, reduces friction and vibration in the data storage device, thereby creating less drag and turbulence. Consequently, by running the data storage device in a less-dense atmosphere, such as an atmosphere of helium or a mixture of helium and oxygen, friction on the recording media is reduced, thereby causing the recording media to require less power in order to spin at a similar rate as the recording media in data storage devices that operate in standard air conditions. The use of helium generally also reduces the operating temperature of the data storage device, as well as the amount of noise it generates.

Smear is common in data storage devices that are sealed and contain helium, because there are far fewer oxygen molecules in such devices than in standard-atmosphere data storage devices. It is desirable, therefore, to increase the concentration of oxygen molecules around the recording head to promote smear oxidation, thereby both mitigating the effects of smear and reducing the temperature around the recording head.

Disclosed herein are slider designs that provide high thermal fly height control (TFC) and high oxygen partial pressure around the recording head with relatively low touchdown power to promote smear oxidation and reduce heating of the recording head. The disclosed slider designs include a trailing pad that includes a mini-pad extending from a main portion of the trailing pad toward a trailing-edge surface of the slider. The mini-pad is connected to the main portion of the trailing pad by a neck portion. The neck portion includes at least one notch such that at least one notch is situated between the mini-pad and the main portion of the trailing pad. In some embodiments, two notches are provided, with one on either side of the neck portion (e.g., on the outer-diameter (OD) and inner-diameter (ID) sides of the neck portion). The notches, which can differ from each other in size and shape (e.g., to account for differences in airflow on the ID and OD sides), regulate (e.g., increase, decrease, redirect) the airflow over the mini-pad, thereby allowing the TFC power to be reduced relative to what it would otherwise be if the notches were not present. In a sense, the notches are TFC efficiency features of the slider. The differences in airflow on the ID and OD sides of the slider can be taken into account in selecting the sizes and shapes of the notches. Although the examples shown and described herein typically use at least one notch to increase airflow over the mini-pad, it is to be appreciated that a notch is not required to increase airflow over the mini-pad. In general, a notch or multiple notches can, for example, increase, decrease, and/or redirect the airflow over the mini-pad.

The new slider designs can generate higher partial pressure than conventional designs while maintaining lower touchdown power and high TFC efficiency, thereby allowing the temperature around the recording head to be reduced without an increase in TFC power, which can extend the lifetime of both the recording head and the data storage device. Another benefit of the new ABS designs is that they discourage the pick-up and build-up of smear. The shapes and dimensions of the mini-pad and the at least one notch can be selected based on the design requirements and manufacturing capabilities and limitations.

It is to be appreciated that although the disclosure below is in the context of HAMR, the disclosed techniques are not limited to devices using a particular recording technology. Rather, the disclosed techniques can be used in any type of data storage device that uses a slider (e.g., MAMR). For example, the disclosed techniques may be used to improve the performance and/or lifetime of a conventional data storage device (e.g., a hard disk drive).

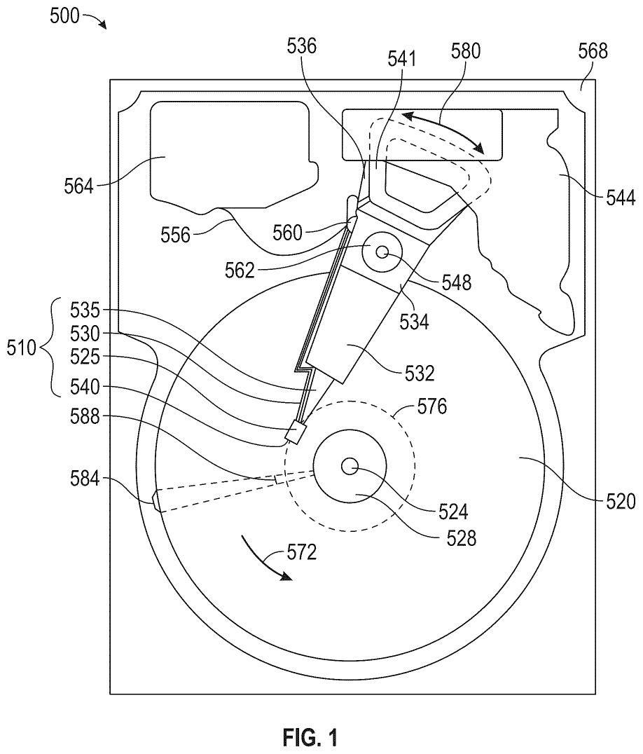

FIG. 1 is a plan view illustrating an example of a data storage device 500, illustrated as a hard disk drive, that may include one or more of the embodiments disclosed herein. FIG. 1 illustrates an example of the functional arrangement of components of the data storage device 500, including a slider 525 that includes a recording head 540. The recording head 540 (which may also be referred to herein as a transducer or a read/write transducer) includes a write element and a read element for respectively writing and reading information stored on a recording medium 520 of the data storage device 500. The data storage device 500 includes at least one head gimbal assembly (HGA) 510, which includes the slider 525, a suspension and actuator arm 530 attached to the slider 525, and a load beam 535 attached to the suspension and actuator arm 530. The data storage device 500 also includes at least one recording medium 520, which may be, for example, a magnetic recording medium, rotatably mounted on a spindle 524, and a drive motor (not shown) attached to the spindle 524 for rotating the recording medium 520. The recording medium 520, which may include a plurality of disks, may be affixed to the spindle 524 with a disk clamp 528.

The data storage device 500 further includes an arm 532 attached to the HGA 510, a carriage 534, a voice-coil motor (VCM) that includes an armature 536 including a voice coil 541 attached to the carriage 534, and a stator 544 including a voice-coil magnet. The armature 536 of the VCM is attached to the carriage 534 and is configured to move the arm 532 and the HGA 510 to access portions of the recording medium 520. The carriage 534 is mounted on a pivot-shaft 548 with an interposed pivot-bearing assembly 562. In the case of an HDD having multiple disks (also sometimes referred to as “platters”), the carriage 534 may be called an “E-block,” or comb, because the carriage 534 is arranged to carry a ganged array of arms (multiple instances of the arm 532) that gives it the appearance of a comb.

An assembly comprising a head gimbal assembly (e.g., HGA 510), including a suspension flexure to which the slider 525 is coupled, an actuator arm (e.g., the arm 532) to which the suspension is coupled, and an actuator (e.g., the VCM) to which the actuator arm is coupled, may be collectively referred to as a head stack assembly (HSA). The HSA also includes a suspension tail. Generally, the HSA is the assembly configured to move the slider 525 to enable the recording head 540 to access portions of the recording medium 520 (e.g., magnetic-recording disks) for read and write operations.

In accordance with some embodiments, electrical signals (for example, current to the voice coil 541 of the VCM, write signals to and read signals from the recording head 540, etc.) are provided by a flexible interconnect cable 556 (which may be referred to as a “flex cable”). Interconnection between the flex cable 556 and the recording head 540 may be provided by an arm-electronics module 560, which may have an on-board pre-amplifier for the read signal, as well as other read-channel and write-channel electronic components. The arm-electronics module 560 may be attached to the carriage 534 as shown. The flex cable 556 is coupled to an electrical-connector block 564, which provides electrical communication through electrical feed-throughs provided by a data storage device housing 568. The data storage device housing 568, in conjunction with a cover (not shown), provides a sealed, protective enclosure for the information storage components of the data storage device 500.

In accordance with some embodiments, other electronic components, including a disk controller and servo electronics such as a digital-signal processor (DSP), provide electrical signals to the drive motor, the voice coil 541 of the VCM, and the recording head 540 of the HGA 510. The electrical signal provided to the drive motor enables the drive motor to spin, thereby providing a torque to the spindle 524, which is in turn transmitted to the recording medium 520 that is affixed to the spindle 524 by the disk clamp 528; as a result, the recording medium 520 spins in a direction 572. Because it is spinning, the recording medium 520 creates a cushion of air that acts as an air-bearing on which the air-bearing surface (ABS) of the slider 525 rides so that the slider 525 flies above the surface of the recording medium 520 without making contact with a thin magnetic-recording layer of the recording medium 520 in which information is recorded.

The electrical signal provided to the voice coil 541 of the VCM enables the recording head 540 of the HGA 510 to access a track 576 on which information is recorded. Thus, the armature 536 of the VCM swings through an arc 580, which enables the HGA 510 attached to the armature 536 by the arm 532 to access various tracks on the recording medium 520. Information is stored on the recording medium 520 in a plurality of sectored tracks arranged in sectors on the recording medium 520, for example, sector 584. Correspondingly, each track is composed of a plurality of sectored track portions, for example, the sectored track portion 588. Each sectored track portion 588 includes recorded data and a header containing a servo-burst-signal pattern, for example, an ABCD-servo-burst-signal pattern, information that identifies the track 576, and error correction code information. In accessing the track 576, the read element of the recording head 540 of the HGA 510 reads the servo-burst-signal pattern, which provides a position-error-signal (PES) to the servo electronics, which controls the electrical signal provided to the voice coil 541 of the VCM, enabling the recording head 540 to follow the track 576. Upon finding the track 576 and identifying a particular sectored track portion 588, the recording head 540 either reads data from the track 576 or writes data to the track 576, depending on instructions received by the disk controller from an external agent, for example, a microprocessor of a computer system to which the data storage device 500 is connected.

For reading the information stored on the recording medium 520, the recording head 540 may include only one read sensor, or it may include multiple read sensors. The read sensor(s) in the recording head 540 may include, for example, one or more giant magnetoresistance (GMR) sensors, tunneling magnetoresistance (TMR) sensors, or another type of magnetoresistive sensor. When the slider 525 passes over a track 576 on the recording medium 520, the recording head 540 detects changes in resistance due to magnetic field variations recorded on the recording medium 520, which represent the recorded bits.

The data storage device 500 may be what is at times referred to as a “hybrid drive.” A hybrid drive refers generally to a storage device having functionality of both a traditional hard disk drive (HDD) combined with a solid-state storage device (SSD) using non-volatile memory, such as flash or other solid-state (e.g., integrated circuits) memory, which is electrically erasable and programmable.

Because operation, management, and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Furthermore, a hybrid drive may be architected and configured essentially as two storage devices in a single enclosure, e.g., a traditional HDD and a SSD, with either one or multiple interfaces for host connection.

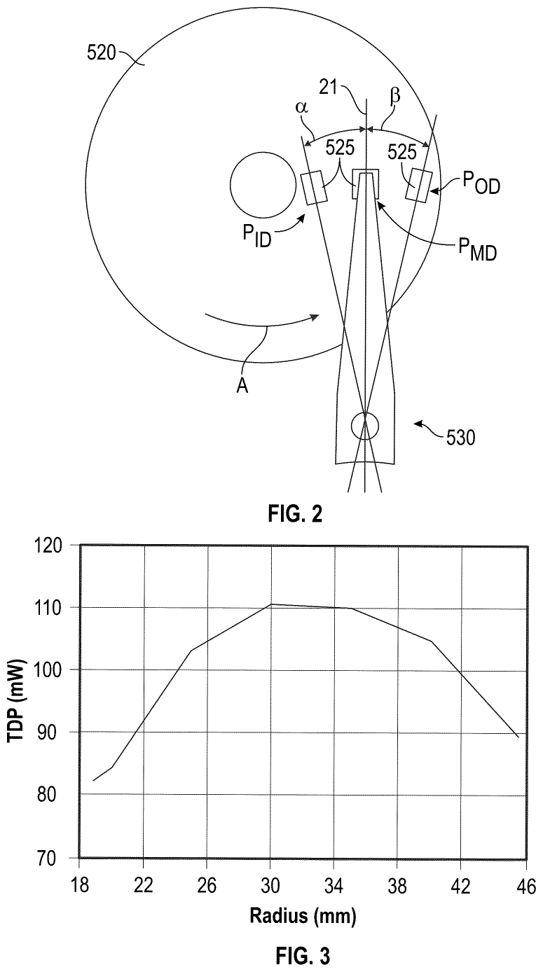

The airflow produced by the spinning recording medium 520 is dependent on the position of the slider 525 over the recording medium 520. FIG. 2 is a diagram showing skew angles of a slider 525 at different positions with respect to the recording medium 520. The suspension and actuator arm 530 supports the slider 525 above the surface of the recording medium 520 at locations including an ID position P_{ID}, an OD position P_{OD}, and positions between P_{ID} and P_{OD}, including the mid-disk (MD) position P_{MD}. As the recording medium 520 spins, it produces airflow in a direction tangential to the recording medium 520 in the direction the recording medium 520 spins, as shown by the arrow A. When the slider 525 is at the mid-disk position P_{MD}, the centerline 21 of the slider 525 is approximately aligned with the direction of the airflow produced by the recording medium 520, and therefore the skew angle is 0 (zero). When the slider 525 is at other positions over the recording medium 520, however, the centerline 21 of the slider 525 is not aligned with the direction of the airflow produced by the recording medium 520. The angle of misalignment of the direction of the airflow and the centerline 21 of the slider 525 is known as the skew angle. The skew angle affects the aerodynamic characteristics of the slider ABS. Generally, the greater the skew angle, the lower the lift produced for a given airflow velocity. As shown in FIG. 2, when the slider 525 is at the ID position P_{ID}, the skew angle is α, which is the maximum skew angle in the ID direction. When the slider 525 is at the OD position P_{OD}, the skew angle is β, which is the maximum skew angle in the OD direction.

The airflow velocity produced by the spinning recording medium 520 is dependent on the distance between the slider 525 and the center of the recording medium 520. At slider 525 fly heights, the tangential airflow produced by the recording medium 520 is close to the tangential velocity of the recording medium 520. This tangential velocity is equal to (RPM)×2πR, where RPM is the number of rotations per minute of the recording medium 520, and R is the distance from the location of the slider 525 to the center of the recording medium 520. As a result of the skew angle's effect on lift and the variation in tangential airflow depending on the position of the slider 525 above the recording medium 520 surface, the slider 525 tends to fly at its highest level above the disk at the mid-disk position P_{MD} and progressively lower toward the ID and OD to minimum fly-height levels at the ID position P_{ID} and the OD position P_{OD}. This phenomenon is known as mid-disk (MD) hump. In accordance with some embodiments, the skew angle and the variability in airflow can be taken into account when designing the ABS of the slider 525 (e.g., to design the size and shape of the at least one notch 182), as described further below.

Some data storage devices 500 use a slider 525 equipped with a heater that heats the portion of the slider 525 on which the recording head 540 is mounted to reduce the distance between the recording head 540 and the recording medium 520 as the slider 525 flies over the recording medium 520. A thermal fly-height control (TFC) supplies the heater with electric current to generate heat that causes the portion of the slider 525 on which the recording head 540 is mounted to protrude by thermal expansion, which leads to decreased clearance between the recording medium 520 and the recording head 540.

Touchdown measurement enables estimation of the clearance between the recording head 540 and the recording medium 520 in data storage devices 500 that use TFC. The power required to cause the thermal protrusion to contact the recording medium 520 is the touchdown power (TDP). Once the TDP is determined (e.g., during a calibration procedure), the power supplied by the TFC can be backed off from the TDP level to obtain a desired clearance between the recording head 540 and the recording medium 520. The TFC efficiency, which has units of distance/power (e.g., nm/mW), is a measure of the amount of power that must be applied by the TFC to cause a specified protrusion distance. The pull-back (PB) efficiency, which also has units of distance/power (e.g., nm/mW), is a measure of the amount by which the power supplied by the TFC must be backed off to achieve a desired spacing between the recording medium 520 and the recording head 540 protrusion. By measuring the TDP as the slider 525 flies over different portions of the recording medium 520 (i.e., at different distances from the center of the recording medium 520, such as ID, MD, and OD), a TDP profile may be generated to plot the TDP versus recording medium 520 radius. Similarly, by determining the TFC efficiency (or PB efficiency) at different slider 525 positions over the disk, a TFC efficiency profile (or PB efficiency profile) may be determined.

The MD hump is reflected in plots of the TDP profile as a TDP hump. FIG. 3 illustrates an exemplary TDP profile for an example slider 525. In the example plot of FIG. 3, the TDP peaks at around MD (at a power level over 110 mW approximately 30 mm from the disk center) and is lower at both ID (around 80 mW approximately 18 mm from the disk center) and OD (around 90 mW approximately 46 mm from the disk center). Thus, FIG. 3 illustrates that, relative to the amount of power required at ID and OD, more power is required near MD to cause the thermal protrusion to contact the disk, which confirms that the slider 525 flies further away from the disk at MD locations than at locations closer to ID or OD.

The use of TFC can improve the performance of data storage device 500 as described above, but repeated thermal expansion and contraction can shorten the lifetime of the recording head 540. One approach to improve the lifetime of the recording head 540 is to generate higher air pressure at the recording head 540 as the slider 525 flies, with the goal being to reduce the temperature around it. Another approach is to reduce the TFC touchdown (TD) power to reduce heating of the recording head 540. There is tension between these two approaches, however. ABS designs that provide higher pressure at the recording head 540 generally also have higher TD power, which may offset the cooling effect of the higher pressure. Therefore, there is a need for alternative approaches that can reduce the temperature at the recording head 540 without a commensurate increase in TD power.

Another objective in some embodiments is to increase the partial pressure around the recording head 540 without increasing acoustic emission (AE) oscillation. As will be appreciated, AE oscillations are due to vibration or sound waves generated within the data storage device 500 during its operation, which can be caused by mechanical components such as the recording medium 520 as it spins and/or movement of the suspension and actuator arm 530. Excessive vibrations or acoustic noise can interfere with the precise movement of the recording head 540, leading to data access delays or errors. If the frequency of AE oscillation matches the natural resonance of the components of the data storage device 500, the vibration can be amplified, causing wear or damage over time.

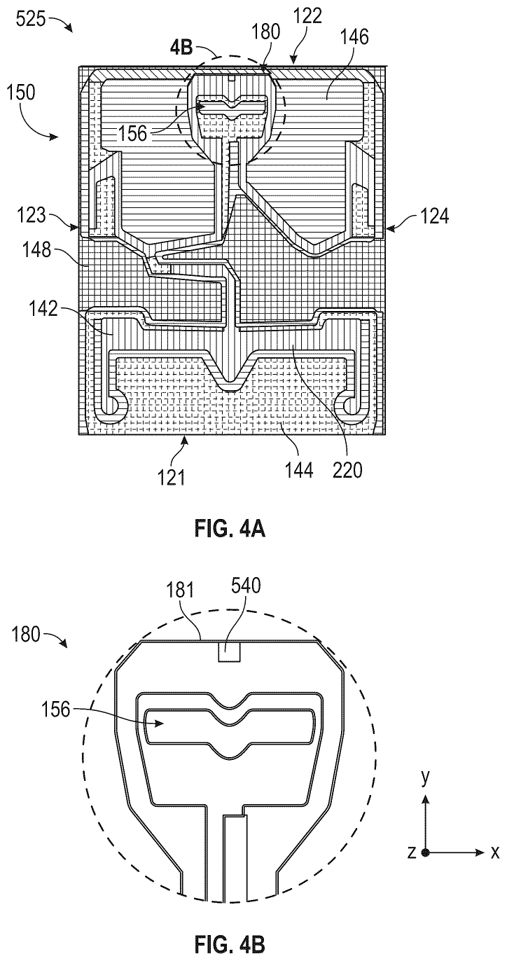

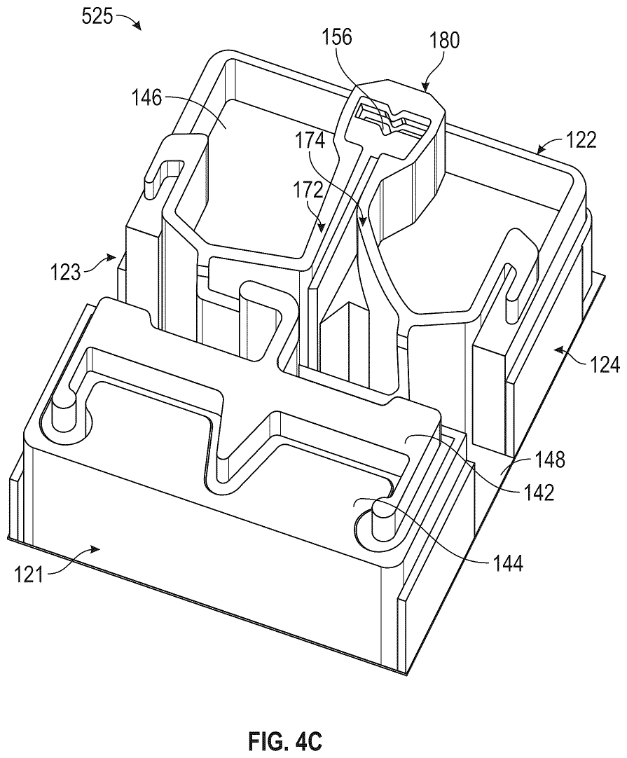

FIG. 4A is an ABS view of a slider 525. The slider 525 has a leading-edge surface 121, a trailing-edge surface 122 opposite and substantially parallel to the leading-edge surface 121, a first side-edge surface 123 extending between the leading-edge surface 121 and the trailing-edge surface 122, and a second side-edge surface 124 opposite the first side-edge surface 123 and extending between the leading-edge surface 121 and the trailing-edge surface 122. The first side-edge surface 123 and second side-edge surface 124 are substantially perpendicular to both the leading-edge surface 121 and the trailing-edge surface 122. The slider 525 includes a leading pad 220 near the leading-edge surface 121 and a trailing pad 180 near the trailing-edge surface 122 of the slider 525.

The ABS 150 of the slider 525 includes surfaces at several levels in x-y planes. The top of the leading pad 220 and top of the trailing pad 180 are at the level 142. The level 142 is at a level that, when the ABS 150 is facing upward, is the highest level of the ABS 150. When the slider 525 is installed in a data storage device 500, the level 142 is the level of the ABS 150 that is closest to the recording medium 520. (It is to be understood that when the recording medium 520 spins, certain surfaces at the level 142 (e.g., the top surface of the leading pad 220) may fly further from the recording medium 520 than other surfaces of the slider 525 at the same level 142 (e.g., the top surface of the trailing pad 180) due to the pitch angle of the slider 525 as it flies. Nevertheless, for purposes of the description herein, the level 142 is said to be closest to the recording medium 520 when the slider 525 is situated in a data storage device 500.)

The ABS 150 also includes various surfaces at a level 144. The level 144 is recessed from the level 142. The recess distance may be, for example, between about 100 nm and about 200 nm. For example, the distance by which the level 144 is recessed from the level 142 may be approximately 150 nm. In other words, the height difference between the level 142 and the level 144 may be about 150 nm.

The ABS 150 also includes various surfaces at a level 146. The level 146 is recessed from the level 142 and the level 144. The level 146 may be, for example, approximately 250 nm to 2500 nm below the level 142. When the slider 525 is installed in a data storage device 500, the level 146 is further from the recording medium 520 than are the level 142 and the level 144.

The ABS 150 also includes various surfaces at a level 148. The level 148 is recessed from the level 142, the level 144, and the level 146. The level 148 may be, for example, approximately 300 to 3000 nm (0.3-3 microns) below the level 142. When the slider 525 is installed in a data storage device 500, the level 148 is further from the recording medium 520 than are the level 142, the level 144, and the level 146.

FIG. 4B is a closer view of the trailing pad 180 shown in FIG. 4A. As illustrated, the trailing pad 180 has a recording head 540 mounted on it. The recording head 540 is situated near the trailing surface 181 of the trailing pad 180, which is close to the trailing-edge surface 122 of the slider 525. FIG. 4B includes axes for a rectangular coordinate system. The x-direction is the cross-track direction, the y-direction is the down-track direction, and the z-direction is the vertical direction (which can also be referred to as the fly-height direction).

The trailing pad 180 of the slider 525 example also includes an efficiency-flattening hole (EFH) 156. As the slider 525 flies over the disk, the EFH 156 can store air and re-direct it onto the recording head 540 in a substantially uniform way that is largely independent of the location of the slider 525 over the recording medium 520 (i.e., the airflow is approximately consistent regardless of whether the slider flies at ID, MD, or OD). Efficiency-flattening holes are described in more detail in, for example, U.S. Pat. No. 9,691,422, which is hereby incorporated by reference in its entirety for all purposes. The EFH 156 is an optional feature of the slider 525.

FIG. 4C is a perspective view of the slider 525 of FIGS. 4A and 4B with the ABS 150 oriented upward. As shown, in addition to the features already described, the slider 525 may also include first and second arms 172, 174 that connect to and extend from the trailing pad 180 toward the leading-edge surface 121. The first and second arms 172, 174 may be separated by an etched cavity and have tapered or stepped leading edges. In some embodiments, the first and second arms 172, 174 form a channel through which air flows when the slider 525 flies over the recording medium 520. Additional stepped surfaces may also be formed at various other locations on the slider 525, as illustrated in FIGS. 4A, 4B, and 4C.

It is to be understood that when the slider 525 is installed in a data storage device 500, the ABS 150 will be oriented downward, facing the recording medium 520. For ease of explanation, this document adopts the convention of illustrating and describing the slider 525 with the ABS 150 facing upward, as shown in FIG. 4C. With the slider 525 so oriented, the level 142 is illustrated and sometimes described as being “above” the levels 144, 146, and 148; the level 144 is illustrated and sometimes described as being “below” the level 142 and “above” the levels 146 and 148; the level 146 is illustrated and described as being “below” the levels 142 and 144 and “above” the level 148; and the level 148 is illustrated and described as being “below” the levels 142, 144, and 146. Of course, when the slider 525 is installed in a data storage device 500, the ABS 150 will be oriented downward, toward the recording medium 520. Consequently, the level 142 will be the level closest to the recording medium 520, making it the lowest level, and levels 144, 146, and 148 will be progressively further away from the recording medium 520.

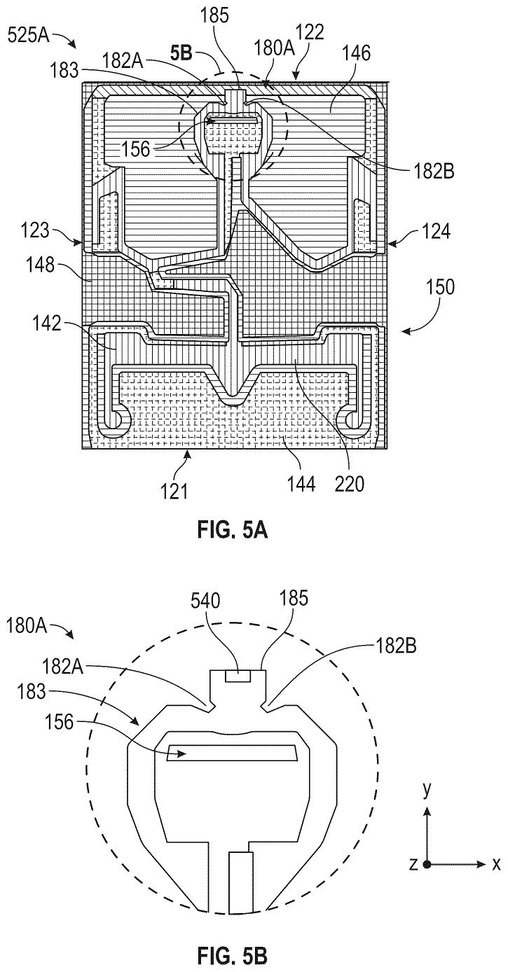

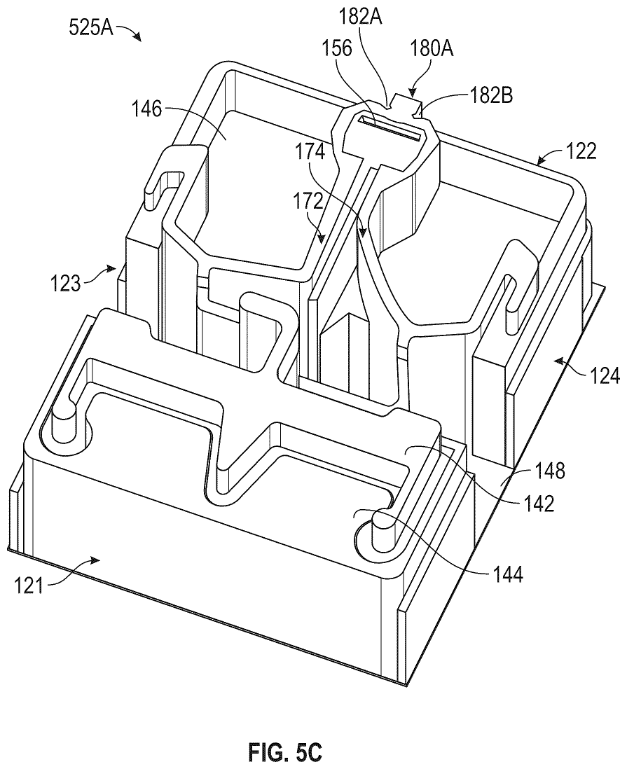

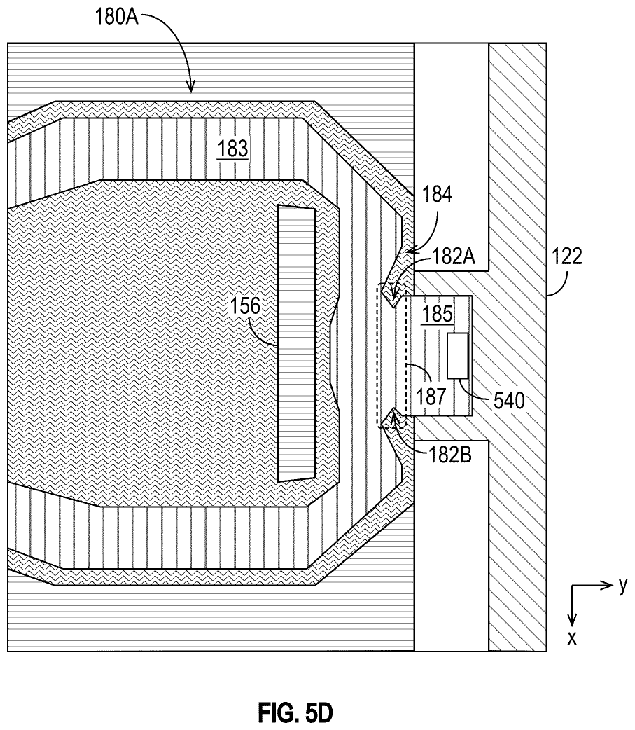

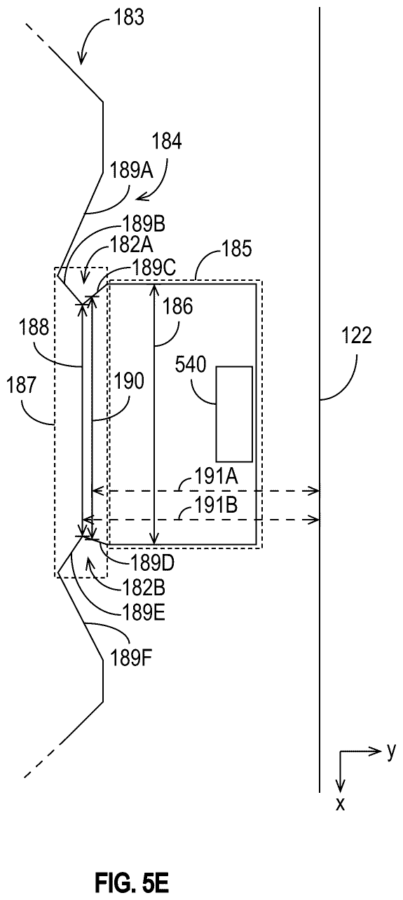

FIGS. 5A, 5B, 5C, 5D, and 5E illustrate an example of a slider 525A that can reduce the temperature around the HAMR head while minimizing or eliminating undesirable degradations to performance in accordance with some embodiments. FIG. 5A is an ABS view of the slider 525A. FIG. 5B is a closer view of the trailing pad 180A shown in FIG. 5A. FIG. 5C is a perspective view of the slider 525A of FIGS. 5A and 5B with the ABS 150 oriented upward. FIGS. 5D and 5E are enlarged views of portions of the trailing pad 180A.

The slider 525A includes many of the same features as the slider 525 described above in the context of FIGS. 4A, 4B, and 4C. Those features have the same reference numerals in one or more of FIGS. 5A, 5B, 5C, 5D, and 5E, and the descriptions of those features provided in the context of FIGS. 4A, 4B, and 4C apply to FIGS. 5A, 5B, 5C, 5D, and 5E and are not repeated here. For example, the statement that the EFH 156 is an optional feature of the slider 525 also applies to the EFH 156 shown in the slider 525A.

The slider 525A includes a trailing pad 180A. With specific reference to FIGS. 5B, 5D, and 5E, the trailing pad 180A comprises a main portion 183, a mini-pad 185, and a neck portion 187 that is situated between and connects the mini-pad 185 to the main portion 183. As explained further below, the main portion 183, mini-pad 185, and neck portion 187 may be created during the slider 525A manufacturing process by etching (e.g., using ion milling).

The main portion 183 can have any suitable shape and features. In the illustrated example, the main portion 183 has a rear edge 184, located on the trailing side of the main portion 183, that includes at least one surface that is not parallel to the trailing-edge surface 122 of the slider 525A. For example, as shown in FIG. 5E, the rear edge 184 of the main portion 183 includes the surface 189A and the surface 189F, neither of which is parallel to the trailing-edge surface 122. As explained below, in some embodiments, the surface 189A and the surface 189F in FIG. 5E partially define the notch 182A and notch 182B, respectively.

The mini-pad 185 extends away from the main portion 183 toward the trailing-edge surface 122 of the slider 525A. In the illustrated example, the mini-pad 185 has a substantially rectangular shape in the ABS view (e.g., in FIGS. 5A, 5B, 5D, and 5E). A recording head 540 may be situated on the mini-pad 185. The size and shape of the mini-pad 185 can be selected during the design process to meet performance objectives. In some embodiments, the mini-pad 185 is narrow in the cross-track direction (e.g., less than about 80 microns (μm) or less than about 11% of the total width of the slider 525A). In some embodiments in which the recording head 540 comprises a HAMR device, the width of the mini-pad 185 is preferably close to (slightly larger than) the width of the HAMR device in the cross-track direction so as to reduce the likelihood of smear pickup and to mitigate the impact of accumulated smear on the fly height of the slider 525A.

The neck portion 187 attaches the mini-pad 185 to the main portion 183. The neck portion 187 comprises at least one notch 182. In other words, the neck portion 187 can include as few as one notch. In the illustrated example, the neck portion 187 comprises two notches, namely a notch 182A and a notch 182B. The notch 182A is on the OD side of the trailing pad 180A, and the notch 182B is on the ID side of the trailing pad 180A. In the example illustrated in FIGS. 5A, 5B, 5C, 5D, and 5E, the neck portion 187 has a shape that resembles an hourglass due to the presence of the notch 182A and notch 182B. It is to be appreciated that other shapes are possible.

With reference to FIG. 5E, the neck portion 187 has a minimum width 188 in the cross-track direction (i.e., the x-direction, using the axes shown in FIG. 5E), and the mini-pad 185 has a minimum width 186 in the cross-track-direction. In the illustrated example, the minimum width 188 of the neck portion 187 in the cross-track direction is less than the minimum width 186 of the mini-pad 185 in the cross-track direction.

Also with reference to FIG. 5E, the width of the neck portion 187 in the cross-track direction varies depending on the position along the y-axis (the down-track direction). In the illustrated example, the neck portion 187 has a first width 190 in the cross-track direction at a distance 191A from the trailing-edge surface 122 and a second width (shown as the minimum width 188) in the cross-track direction at a distance 191B from the trailing-edge surface 122. It will be apparent from inspection of FIG. 5E that there are many choices for the distance 191A and the distance 191B that will result in two different widths of the neck portion 187 in the cross-track direction.

In the example in FIGS. 5A, 5B, 5C, 5D, and 5E, each of the notch 182A and the notch 182B has an interior that is bounded by a plurality of surfaces. For example, in some embodiments, each of the notch 182A and the notch 182B includes a floor at the level 146. FIG. 5E labels additional surfaces that bound the interiors of the notch 182A and the notch 182B of the illustrated example. For example, FIG. 5E labels the surface 189A, the surface 189B, and the surface 189C, all of which bound the interior of the notch 182A. FIG. 5E also labels the surface 189D, the surface 189E, and the surface 189F, all of which bound the interior of the notch 182B. It is to be appreciated that the interior of each of the notch 182A and the notch 182B can be bounded by more or fewer than three surfaces. Also, although FIGS. 5A, 5B, 5C, 5D, and 5E illustrate the notch 182A and the notch 182B having linear surfaces that bound their interiors, thereby resulting in a piecewise-linear shape in the ABS view, there is no requirement for the surface(s) bounding the interior(s) of the at least one notch 182 to have any particular shape.

Each of the notch 182A and the notch 182B may have any suitable size, shape, and volume. For example, the notch 182A and the notch 182B may be approximate mirror images of each other (e.g., mirror images about an axis in the y-direction using the axes defined in FIGS. 5B, 5D, and 5E).

Alternatively, the notch 182A and notch 182B may differ from each other in one or more respects, such that they are not approximate mirror images of each other. For example, their sizes, shapes, or volumes may be different. It will be appreciated by those having ordinary skill in the art that it may be advantageous for the notch 182A and the notch 182B to differ from each other in size and/or shape to account for different airflows on the ID and OD sides of the trailing pad 180A (e.g., to account for different airflows in the vicinity of and over the recording head 540 at different skew angles). In FIG. 5E, the notch 182A and notch 182B are not mirror images of each other. For example, the surface 189D of the notch 182B is at a larger angle from the trailing-edge surface 122 than is the surface 189C of the notch 182A. In other words, in the example shown in FIGS. 5A-5E, the shape of the notch 182A differs from the shape of the notch 182B (e.g., in the ABS view). In some embodiments, the volume of the notch 182A is larger than the volume of the notch 182B, which can help increase efficiency when the slider 525A flies closer to the OD.

The shapes of the notch 182A and/or notch 182B may be regular or irregular. As will be appreciated by those having ordinary skill in the art, a shape is regular if at least some of its sides and/or interior angles have some relationship to each other (e.g., a rectangle is a regular shape because it has at least two sides of substantially equal lengths, and all of its interior angles are 90 degrees). A shape is irregular if its sides and interior angles are in no particular relation to each other. In other words, an irregular shape has sides and interior angles of any length and size. In the example shown in FIGS. 5A-5E, the notch 182A and the notch 182B have irregular shapes. As shown in FIGS. 5A, 5B, 5D, and 5E, the shape of the notch 182A and/or the notch 182B may be partially or fully piecewise-linear in the ABS view of the slider 525A.

In some embodiments, the effect of the at least one notch 182 (e.g., the notch 182A and notch 182B of the example shown in FIGS. 5A-5E) is to increase airflow over the recording head 540, which improves TFC efficiency and increases partial pressure in the vicinity of the recording head 540 without a substantial (or any) increase in TFC power. Inclusion of an EFH 156 in addition to the at least one notch 182 can also help to create high pressure (e.g., a more consistent/uniform airflow distribution) around the trailing pad 180A. Overall, the new design can be used to provide high partial pressure around the recording head 540 without an increase in TFC power, all while minimizing/mitigating the effects of smear. Simulations show that the disclosed slider 525A designs can increase the concentration of oxygen over/around the recording head 540 as the data storage device 500 operates.

A slider 525A with a trailing pad 180A comprising a main portion 183, a mini-pad 185, and a neck portion 187 (and at least one notch 182) as disclosed herein can be fabricated from a wafer using a photolithography process having two fundamental steps: (a) covering a portion of a surface of the wafer (e.g., using a photoresist mask), and (b) removing substrate material from the exposed (e.g., not covered by the mask) surface of the wafer. Step (a) may be accomplished, for example, using a binary mask having hard edges to create a well-defined pattern in a photoresist layer that is applied to the wafer surface. Step (b) may be accomplished, for example, by lapping, etching, or milling (e.g., using an ion beam) to transfer the photoresist pattern to the wafer surface. The surface of the slider 525A to which the covering is applied and from which material is removed is the surface that will eventually face the recording medium 520 when the slider 525A is used in a data storage device 500, i.e., the ABS 150.

The steps (a) and (b) may be repeated multiple times to create different features of the slider 525A. The following discussion focuses on the ABS 150 features near the trailing-edge surface 122, but it will be appreciated that the other features of the ABS 150 can also be fabricated during the described steps or during other steps of the slider 525A manufacturing process that are known in the art.

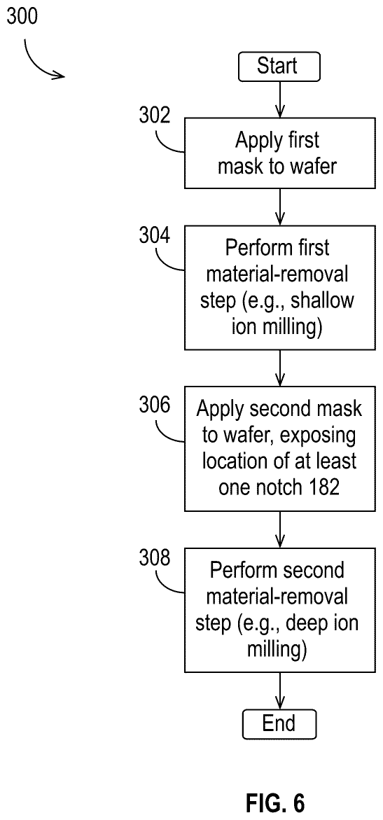

FIG. 6 is a flow diagram illustrating a portion of a method 300 of fabricating a slider 525A with at least one notch 182 (e.g., in a neck portion 187) in accordance with some embodiments. The slider 525A fabrication process can include additional steps that are known in the art but that are not shown in FIG. 6. These additional steps may be performed before, between, and/or after the steps illustrated in FIG. 6. Although the description of the method 300 focuses only the steps of the method 300 related to creating the notches 182, it will be appreciated that other features of the slider 525A can also be created during these steps.

At block 302, a first mask is applied to the wafer. The first mask includes a region that defines the level 142 of trailing pad 180A, as well as the level 142 of other features of the ABS 150 of the slider 525A. At block 304, a first material-removal step is performed to remove material from the wafer. The first material-removal step may use, for example, shallow ion milling. At least part of the leading pad 220 and the trailing pad 180A may be apparent in the slider 525A after block 304 is complete.

After completion of block 304, and potentially additional intervening manufacturing steps, at block 306, a second mask is applied to the wafer. The second mask exposes the location of the at least one notch 182. At block 308, a second material-removal step is performed to remove additional material from the wafer, including material from the interior(s) of the at least one notch 182. After block 308, the slider 525A includes at least one notch 182 in the trailing pad 180A. The at least one notch 182 may be complete after block 308, or its shape, size, interior, etc. may be further refined in later manufacturing steps (e.g., if, after the block 308, the at least one notch 182 has a maximum depth at a first level (e.g., level 144), a second, deeper level (e.g., level 146) may be created in a later step).

After completion of block 308, and potentially additional intervening manufacturing steps, additional masks can be applied and additional material removed from the interior(s) of the at least one notch 182. For example, another mask can be applied to cover a first level and to allow a second level to be created within the interior of one or more of the at least one notch 182. Likewise, different masks can be applied and material removed to create notches 182 having different depths, sizes, volumes, three-dimensional shapes, etc. It will be appreciated by those having ordinary skill in the art that a wide variety of at least one notch 182 can be created using the steps (a) and (b) described above. The examples provided herein are not intended to be limiting.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Although the disclosures herein may be useful in data storage devices 500 that use TFC (e.g., HAMR devices) and have been presented in that context, it is to be understood that the techniques described are not limited to any particular recording technology. For example, the disclosed techniques may be applied to other types of data storage device 500 (e.g., perpendicular magnetic recording (PMR), MAMR, etc.).

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.” To the extent that the terms “include(s),” “having,” “has,” “with,” and variants thereof are used in the detailed description or the claims, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” are used herein to refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The terms “substantially” and “approximately” are used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” or “approximately equal” means that the two lengths are the same for all practical purposes, but they may not (and need not) be precisely equal at sufficiently small scales. As another example, a structure that is “substantially vertical” or “approximately vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A slider for a data storage device, the slider comprising:
a leading-edge surface;
a trailing-edge surface, wherein the trailing-edge surface is substantially parallel to the leading-edge surface; and
a trailing pad situated closer to the trailing-edge surface than to the leading-edge surface, wherein the trailing pad comprises:
a main portion,
a mini-pad situated between the main portion and the trailing-edge surface, and
a neck portion connecting the mini-pad to the main portion, wherein a minimum width of the neck portion in a cross-track direction is less than a minimum width of the mini-pad in the cross-track direction.

2. The slider recited in claim 1, wherein, in an air-bearing surface (ABS) view of the slider, a shape of the mini-pad is substantially rectangular.

3. The slider recited in claim 1, wherein, in an air-bearing surface (ABS) view of the slider, at least one surface of a rear edge of the main portion of the trailing pad is not parallel to the trailing-edge surface.

4. The slider recited in claim 1, wherein, in an air-bearing surface (ABS) view of the slider, the neck portion is substantially hourglass-shaped.

5. The slider recited in claim 1, wherein, in an air-bearing surface (ABS) view of the slider, a first width of the neck portion in the cross-track direction at a first distance from the trailing-edge surface differs from a second width of the neck portion in the cross-track direction at a second distance from the trailing-edge surface.

6. The slider recited in claim 1, wherein, in an air-bearing surface (ABS) view of the slider, the neck portion comprises at least one notch.

7. The slider recited in claim 6, wherein the at least one notch comprises a first notch on an outer-diameter side and a second notch on an inner-diameter side.

8. The slider recited in claim 7, wherein a shape of the first notch differs from a shape of the second notch.

9. The slider recited in claim 8, wherein a volume of the first notch is larger than a volume of the second notch.

10. The slider recited in claim 8, wherein a shape of at least one of the first notch or the second notch is irregular.

11. A method of making the slider recited in claim 6, comprising:
applying a mask to the slider, wherein the mask exposes a first region corresponding to the at least one notch; and
while the mask is in place, performing an etching step to create the at least one notch.

12. The slider recited in claim 1, wherein the trailing pad further comprises:
an efficiency-flattening hole (EFH), and
a recording head situated between the EFH and the trailing-edge surface.

13. A data storage device, comprising:
a recording medium; and
a slider comprising:
a leading-edge surface,
a trailing-edge surface substantially parallel to the leading-edge surface, and
an air-bearing surface (ABS), comprising:
a trailing pad situated closer to the trailing-edge surface than to the leading-edge surface, wherein the trailing pad comprises:
a main portion,
a mini-pad extending from the main portion toward the trailing-edge surface, and
at least one notch between the mini-pad and the main portion of the trailing pad.

14. The data storage device recited in claim 13, wherein the at least one notch comprises:
a first notch on an outer-diameter side; and
a second notch on an inner-diameter side.

15. The data storage device recited in claim 14, wherein, in an ABS view of the slider, a shape of the first notch differs from a shape of the second notch.

16. The data storage device recited in claim 15, wherein the shape of the first notch is irregular and/or the shape of the second notch is irregular.

17. The data storage device recited in claim 15, wherein the shape of the first notch and/or the shape of the second notch is a piecewise-linear shape.

18. The data storage device recited in claim 14, wherein a volume of the first notch is larger than a volume of the second notch.

19. The data storage device recited in claim 13, wherein the ABS further comprises:
an efficiency-flattening hole (EFH), and
a recording head situated on the mini-pad,
wherein the mini-pad is situated between the EFH and the trailing-edge surface.

20. A data storage device, comprising:
a recording medium; and
a slider, comprising:
means for writing to the recording medium; and
a trailing pad, comprising:
a main portion,
a mini-pad extending from the main portion toward a trailing-edge of the slider, and
a neck portion connecting the mini-pad to the main portion, wherein a minimum width of the neck portion in a cross-track direction is less than a minimum width of the mini-pad in the cross-track direction.
